(19) United States
(12) Patent Application Publication
(10) Pub. No.: US 2006/0098447 A1
(43) Pub. Date: May 11, 2006

(54) Led projector for asymmetrical illumination

(76) Inventors: Manfred Griesinger, Leonberg (DE); Markus Hartlieb, Walddorfhaslach (DE); Wilheim Kincses, Esslingen (DE); Hans-Georg Leis, Esslingen (DE); Siegfried Rothe, Denkendorf (DE)

Correspondence Address: AKERMAN SENTERFITT, 222 LAKEVIEW AVENUE, SUITE 400, P.O. BOX 3188, WEST PALM BEACH, FL, 33401, US

(21) Appl. No.: 10/532,621

(22) PCT Filed: Oct. 17, 2003
(86) PCT No.: PCT/EP03/11516

§ 371 Date: Nov. 28, 2005

(30) Foreign Application Priority Data
Oct. 24, 2002 (DE) 102 49 819.9
Mar. 10, 2003 (DE) 103 10 263.9

(51) Int. Cl. F21V 7/00

(52) U.S. Cl. 362/514

(57) ABSTRACT

The invention relates to a novel projector which has an asymmetrical illumination characteristic, and a clear light-dark limit, and uses almost the entire radiation power outputted from the semiconductor light source. To this end, the projector consists of a field of individual semiconductor light sources which are provided with optical elements having a novel form. Said optical elements have as flat a form as possible, such that the light admission inlet of the optical element has an elongated, essentially rectangular form. Furthermore, the optical elements comprise a central region, perpendicular to the light admission surface (F), the projection of said central region into a two-dimensional plane corresponding to a cylindrical two-dimensional Cartesian oval. According to the invention, in order to better use the light emitted from the semiconductor light source, the light emergence surface (G) of the optical element, in the form of a Cartesian oval, is combined with a parabolic reflector (A, B).

### BACKGROUND OF THE INVENTION

1. Field of the Invention

The invention relates to an LED headlight having an asymmetrical illumination characteristic, and to a method for operating such a headlight in accordance with the preamble of patent claims 1 and 10.

2. Related Art of the Invention

Controlling a vehicle in traffic is a demanding, highly dynamic task. It imposes considerable demands on visual perception, cognitive processing and motor coordination of the driver. In the literature there is a general consensus that about 90 percent of the information relevant in road traffic is picked up by the sense of sight. It is accordingly important to have good illumination of the traffic space at twilight and when it is dark and in weather situations in which natural light is insufficient. The ECE specifications that are still valid at the present time for asymmetrical low-beam light on European roads represent a compromise between good vision and impeding other road users as little as possible. A vehicle headlight is to be configured to the effect that it shapes the light emitted by it such that a light distribution prescribed for vehicle headlights is produced as a result of the superposition of the emerging light; in particular, the formation of a distinct bright-dark boundary and an asymmetrical characteristic of the illumination are necessary in order to avoid dazzling oncoming traffic.

The illumination system described in U.S. Pat. No. 6,144,158 A uses an array of semiconductor lasers or alternatively a deflection device for the light beam of an individual semiconductor laser to generate an illumination characteristic which has the distinct bright-dark boundary required in road traffic and an asymmetrical characteristic. However, the use of an expensive laser light source that is required for light concentration but is not very robust in respect of vibrations has a disadvantageous effect in this case with regard to the possibilities of an economically practical realization.

A headlight realized on the basis of cost-effective LED light sources is disclosed in the document DE 100 05 795 A1. In this case, a headlight having a variable luminous characteristic is realized by an array of individual emitters with at least one optical element arranged in front of each individual emitter. Each of said optical elements can be displaced with respect to the individual elements in all three spatial directions in order to influence the respective light beam emitted by the individual light element. In this way, it is possible to achieve a variable control of the beam bundle emitted by the headlight. However, the rotationally symmetrical light distribution that has a large aperture angle and is typical of the LED optical element used means that it is not possible to produce a light distribution which has a distinct bright-dark boundary and accords with the road traffic specifications.

### SUMMARY OF THE INVENTION

Therefore, it is an object of the invention to find an illumination device which can be produced cost-effectively and has an asymmetrical illumination characteristic, which at the same time has a distinct bright-dark boundary and, in this case, utilizes as far as possible the entire radiation power emitted by the semiconductor light source.

The object is achieved by means of an illumination device and a method suitable for operating such a device having the features of patent claims 1 and 10. Advantageous refinements and developments of the invention are exhibited by the subordinate claims. The invention is explained below in detail with reference to exemplary embodiments and figures.

The illumination optical element is formed by an array of individual optical elements. In this case, the individual optical elements are embodied as flat as possible in an inventive manner, so that the light entry opening of the optical elements has an elongate, essentially rectangular form. In this case, each individual optical element has, perpendicular to the light entry area, a central region whose projection into a two-dimensional plane corresponds to a cylindrical two-dimensional Cartesian oval. A Cartesian oval is a geometrical area which, as an interface of a refractive medium, collects the light emerging from a focal point at a second focal point even for large aperture angles. In order that the light emerging from the semiconductor light source is utilized even better, in the context of the invention the light exit area of the optical element, said light exit area being shaped in the form of a Cartesian oval, is combined with a parabolic reflector.

### BRIEF DESCRIPTION OF THE DRAWINGS

The advantageous designs of the invention are discussed in detail below by means of figures and on the basis of the mathematical derivation of the geometry of the optical element according to the invention. In this case, proceeding from an advantageous use of the optical elements within headlights, consideration will be given only to the case where the second focal point at which the light beams emerging from the light source meet lies at infinity, i.e. the beam bundle is converted into a parallel beam bundle. The mathematical treatment of the system is greatly simplified in this way. Further figures serve for comprehensively elucidating the advantageous refinements and developments of the invention.

FIG. 1 shows the beam geometry that forms the basis of the refraction at the light exit area of the optical element.

FIG. 2 illustrates the contour line of a Cartesian oval that results from the calculation.

FIG. 3 represents the beam path emerging from a point source and demonstrates the critical angle of reflection resulting from the geometry of the optical element.

FIG. 4 shows a 3-dimensional view of an optical element according to the invention.

FIG. 4a represents the optical element shown in FIG. 4 as a 3-dimensional edge image in four different views.

FIG. 5 shows a cross section through the optical element according to the invention with the required adaptation of the parabolic contour of the reflector.

FIG. 6 shows the energy distribution of the light emerging from the optical element according to the invention.

FIG. 7 schematically shows the part of an alternative embodiment of the optical element on the basis of a compound parabolic reflector.

FIG. 8 schematically shows a further alternative embodiment of the optical element (with a view of the light entry area), by means of which the light cone emerging from the optical element can be curved in a targeted manner.

FIG. 9 shows the energy distribution of an alternative optical element in accordance with FIG. 8.

FIG. 10 describes the positioning of semiconductor light sources at the optical element according to the invention.

### DETAILED DESCRIPTION OF THE INVENTION

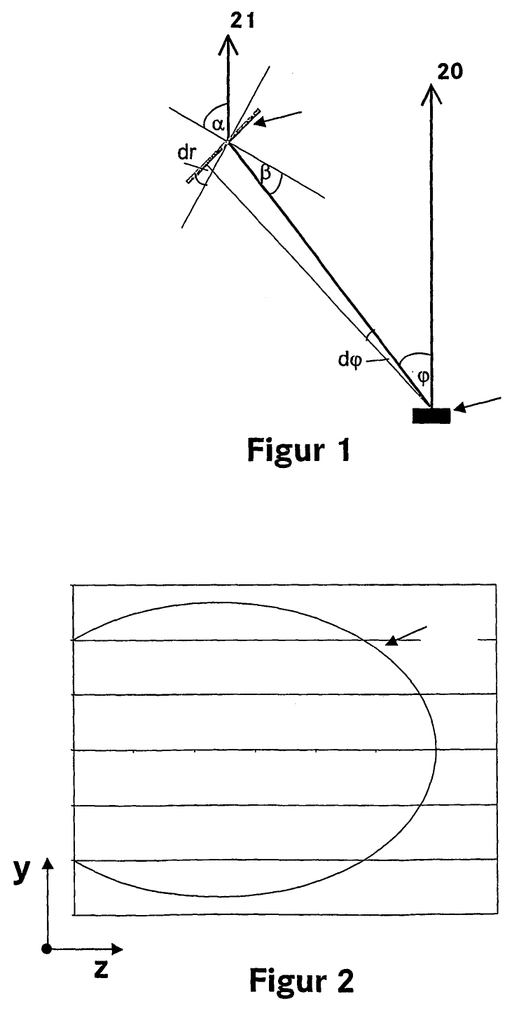

In order to clarify the form of a Cartesian oval, the mathematical derivation of the contour curve thereof is demonstrated below. For this purpose, FIG. 1 shows the beam geometry that forms the basis of the refraction. In this case, two light beams 20 and 21 are demonstrated schematically proceeding from a light source 60. Light beam 20 is in this case intended to represent that light which emerges perpendicularly proceeding from the light source 60, without refraction at the wall 10 of the optical element, from the light exit area thereof. By contrast, light beam 21 emerges at an angle φ from the semiconductor light source and impinges on the inner side of the wall 10 at an angle dφ relative to the normal. For this reason, the light beam 21 is refracted and emerges at an angle α from the optical element at the light exit area thereof. Since the wall 10 has the contour of a Cartesian oval in an inventive manner, the light beam 21 is deflected in such a way that, after emerging from the optical element, it runs parallel to the unrefracted light beam 20. This geometry of the beam path demonstrated in FIG. 1 gives rise to the following relationship
α−β=φ (1.1)
in this case, φ is the polar coordinate angle, α is the angle of emergence from the refractive medium, and β is the angle of incidence in the medium. The following holds true according to the law of refraction:

$$\frac{sin α}{sin β} = n \qquad ( 1.2 )$$

The first step is to calculate, in a manner dependent on φ, the required angle β of incidence in order to permit the light to emerge from the element in parallel-directed fashion. It follows from (1.1) and (1.2) that:

$$\frac{sin ( φ + β )}{sin β} = n \qquad ( 1.3 )$$

and the function sought is calculated from:

$$β = arctan \frac{sin φ}{n - cos φ} \qquad ( 1.4 )$$

This function specifies the angle β of incidence as a function of the polar coordinate angle φ. The contour is then calculated in the next step. It follows from FIG. 1 that:

$$\frac{ⅆ r}{ⅆ φ} = r \cdot tan β \qquad ( 1.5 )$$

With equation (1.4), this gives rise to the differential equation

$$\frac{dr}{r} = \frac{sin φ}{n - cos φ} d φ \qquad ( 1.6 )$$

This equation can be solved in an analytical form by substitution:

$$\frac{r}{{r}_{0}} = \frac{n - cos {φ}_{0}}{n - cos φ} \qquad ( 1.7 )$$

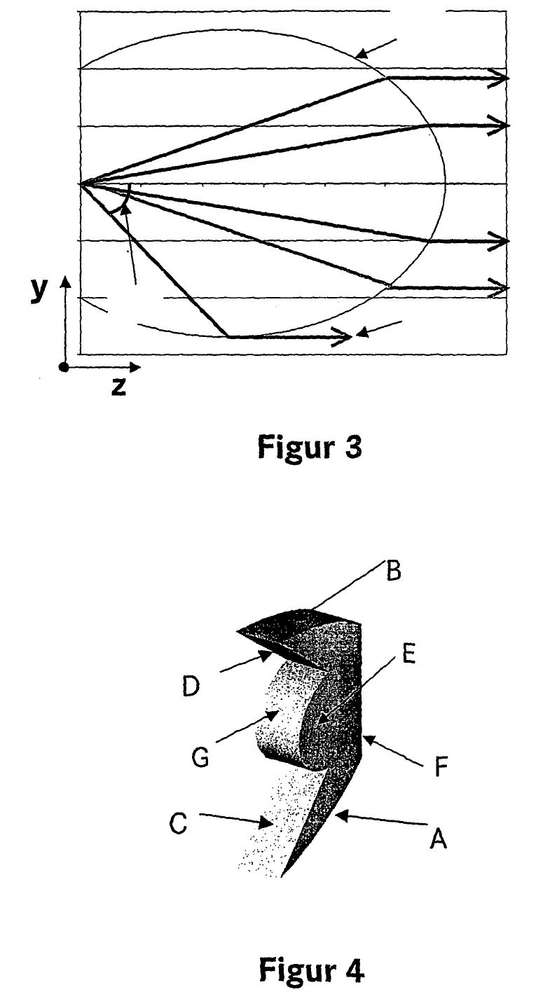

This is the equation sought in polar coordinates of the contour line 11 of the Cartesian oval as illustrated in FIG. 2. In this case, r₀ is the radius which is assigned to the angle φ₀ and serves for defining the absolute dimension of the contour. It goes without saying that equation 1.7 described in polar coordinates can also be transferred to the Cartesian system of coordinates, which results in the following equation (1.8):

$$\frac{{( n + 1 )}^{2}}{{n}^{2} \cdot {r}_{0}^{2}} \cdot {( x - \frac{{r}_{0}}{n + 1} )}^{2} + \frac{( n + 1 )}{( n - 1 ) \cdot {r}_{0}^{2}} \cdot {y}^{2} = 1 \qquad ( 1.8 )$$

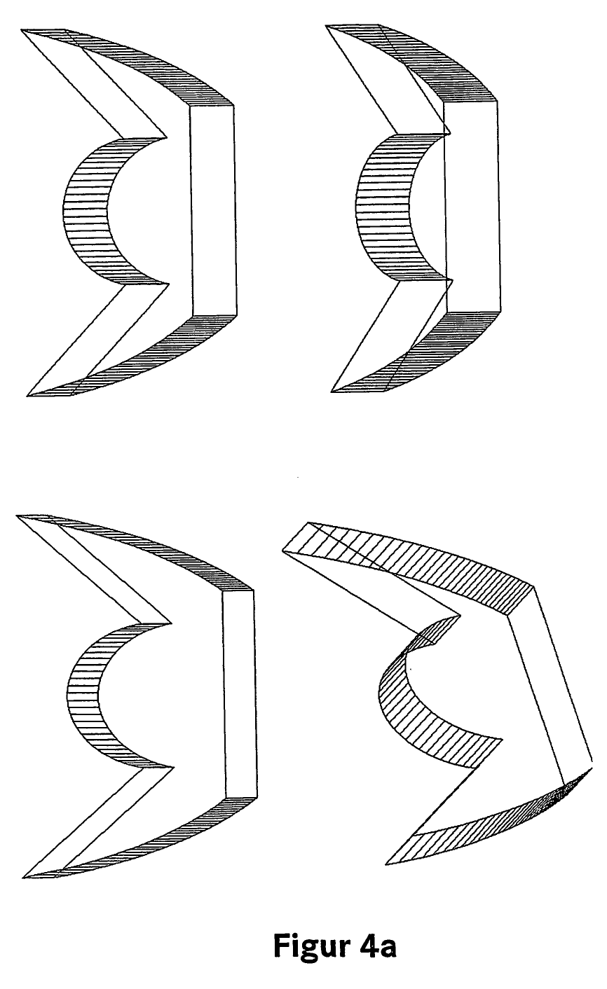

An optical element having an exit area in the form of a Cartesian oval described in accordance with equation 1.8 can parallelize the light of a point source only in a limited angular range, however. This angular range is prescribed by the limiting range of total reflection. The beam path of the light beams 21a-d for a point source 60 and the resulting critical angle φ_{g} are demonstrated in FIG. 3. What is achieved by virtue of the contour of the light exit area of the optical element in the form of a Cartesian oval is that all the light beams 21a-d and 22 emerging from the light source 60 within twice the critical angle φ_{g} emerge from the optical element in parallel fashion. The critical angle φ_{g} is given by the law of refraction (1.2), where the angle of emergence is α=90°. This results in sin β=1/n and the critical angle φ_{g}=90°−β. A critical angle of 48.2° thus results for n=1.5. Radiation lying outside this aperture angle cannot be practically utilized with this element. Since semiconductor light sources generally emit into a much larger angular range, a large part of the light is lost with such elements. Therefore, in order to avoid this problem area, in the context of the invention, the illumination optical element that essentially has the form of a two-dimensional Cartesian oval is combined with a parabolic reflector. Said reflector should likewise have the property that light emerging from the focal point is converted into a parallel bundle. This leads to the element illustrated in FIG. 4, with the side areas A, B and E and the light entry area F. As can be seen from FIG. 4, the inventive optical element is made very flat, the light entry opening F having an essentially rectangular cross section, one dimension of the cross section being significantly smaller than the other; as will be explained below with reference to FIG. 10, the rectangular cross section is advantageously made so narrow that a semiconductor light source 60 can still just be fitted to the optical element in whole-area fashion. For better clarification of the 3-dimensional configuration of the inventive optical element illustrated in FIG. 4, a 3-dimensional edge image of said optical element is represented in four different views in FIG. 4a. In this case, the representations therein emphasize primarily the edges of the optical element, and also in hatched form the side areas A, B and 10 (light exit opening).

In a particularly advantageous manner, it is conceivable for the outer areas A and B of the parabolic reflector either to be mirror-coated or else to be configured such that they are totally reflective. This results in a luminous efficiency of the semiconductor light source that is as optimal as possible since approximately the entire light emerging from the light source is converted into a common parallel beam bundle.

FIG. 5 shows the projection of the side area E of the optical element according to the invention; the contour of the central region shaped as a Cartesian oval and of the parabolic reflector adjoining the outside thereof is clearly manifested here. The reflector is then ideally configured such that, at the regions 40a and 40b of the contour which correspond to the areas C and D, upon light emergence of the beam 23a, refraction takes place in such a way that the beams 23a and 21 emerging from the optical element run parallel. In this case, the course of the light beam 23a should be influenced by rotating the parabolic contour 41a—corresponding to the outer areas A and B of the optical element—in the direction toward 41b. For this purpose, the parabolic contour 41 is to be rotated inward by the required angle in order to avoid a situation where a light beam 23x that does not run parallel to the other parallel beam bundle emerges from the optical element.

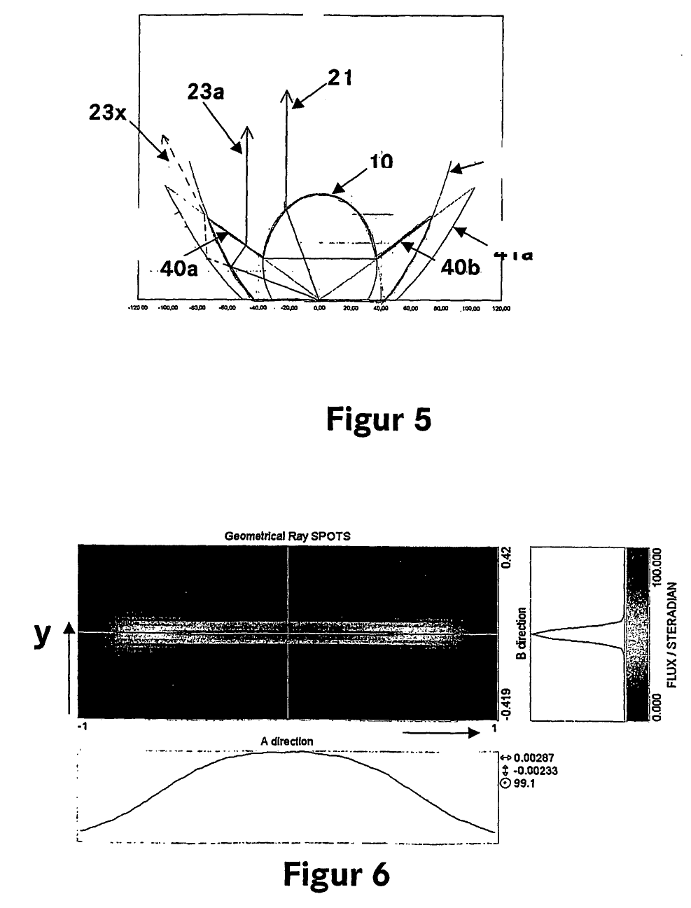

In the case of the inventive configuration of the optical elements of the illumination system, the deflection and orientation of the light predominantly take place in the vertical plane, that is to say that the light is concentrated to form a horizontally running stripe. FIG. 6 shows the energy distribution of the light emerging from the optical element according to the invention as the result of a calculation. The intensity profile of the light emerging from a horizontally arranged optical element is demonstrated in a false color representation in the upper part of the figure. Beside and below that the intensity distribution in the x direction and y direction is demonstrated as a waveform. This makes it clear that the light beam emerging from the optical element is highly concentrated in the y direction. The light intensity emerging from the optical element is locally delimited to a significant extent in the x direction as well. The simulation on which FIG. 6 is based assumed that the light source is fitted centrally with respect to the light entry area F of the optical element, as will be explained in detail later, but it is also conceivable to install the light source at a different position at the light entry area F in order thereby to influence the illumination characteristic of the optical element in a targeted manner.

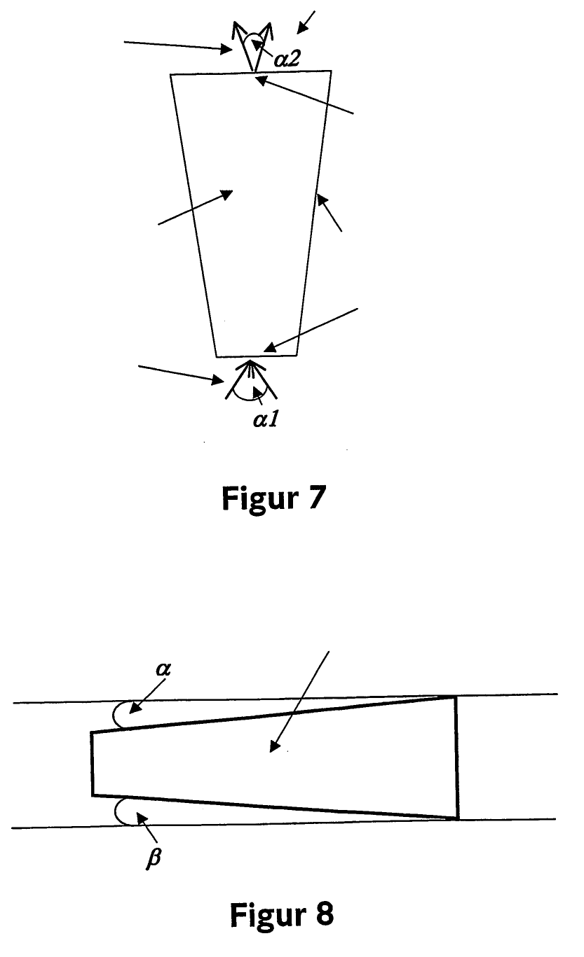

In a particularly advantageous manner, the horizontal width of the light spot can be influenced by inclining the side areas E of the optical element in such a way that the optical element tapers from the light exit area G toward the light entry area F. A corresponding geometry is illustrated in FIG. 7, which shows a side view from the direction of the side area A or B. It becomes clear in this case that, in this beneficial configuration of the invention, the height extent F₁ of the light entry area F of the optical element is less than the height extent G₁ of the light exit area 10 thereof. Such elements, in particular also with parabolic side areas, are known from solar technology (CPC, Compound Parabolic Concentrator). The following relationship holds true:

$$\frac{sin α 1}{sin α 2} = \frac{{K}_{i}}{{F}_{l}} \qquad ( 1.8 )$$

where a1 and a2 describe the respective angular range within which the light beams (25, 26) taken up by the optical element, or at which they then emerge from the optical element. It is apparent from equation (1.8) that enlarging the exit area decreases the angular range into which the light is emitted. In a particularly beneficial manner, it is appropriate to provide a largest possible acceptance angle in the beam direction as well, in order to avoid optical losses. This can be achieved either by mirror-coating or the corresponding configuration of the curvature of the side areas E, so that total reflection arises there. In FIG. 7, by way of example, a dashed line indicates the course of curvature of the side area E for a parabolic curvature. In accordance with the procedure described above and also illustrated in FIG. 5, it is possible, at a Cartesian-oval central region shaped in this way, according to the invention, to adapt a suitable parabolically shaped reflector, for optimum utilization of the light emitted by the light source.

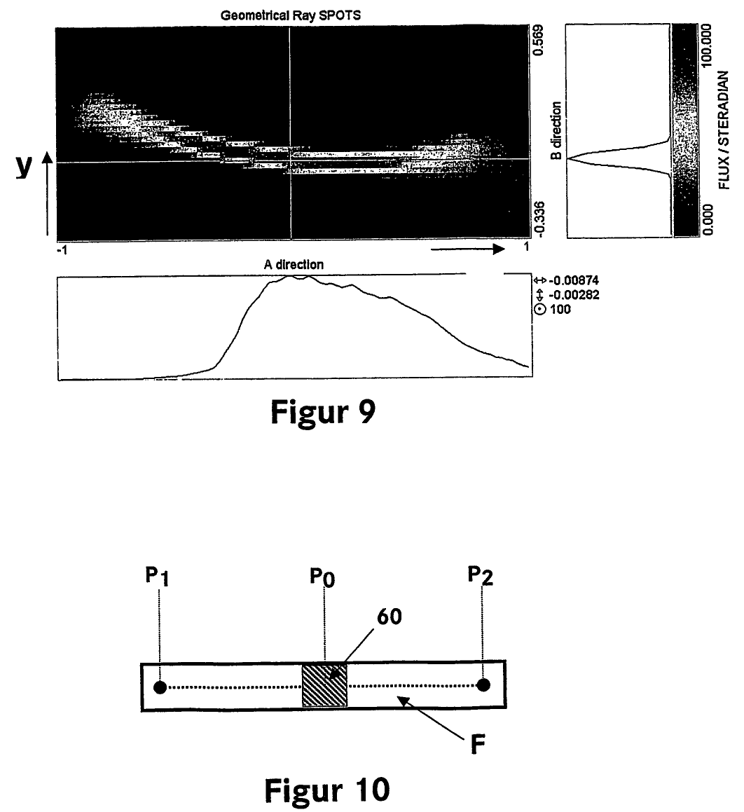

In a further advantageous configuration of the inventive optical element, the cross section of the light entry area F thereof has a trapezoidal form, as illustrated in FIG. 8, in a departure from the generally rectangular form. In this case, the side areas of said trapezoidal form are inclined by the angles β and β with respect to the horizontal. In this case, it is conceivable to choose the two angles α and β of inclination to be identical in terms of their magnitude or else to be different from one another. In accordance with the representations in FIG. 6, FIG. 9 shows the result of a calculation of the energy distribution of the light emerging from the advantageous optical element with inclined side areas. The angles α and β of inclination were chosen as 5° and 7°, respectively, for the calculation. The intensity profile of the light emerging from an essentially vertically arranged optical element is again demonstrated in a false color representation in the upper part of the figure. Beside and below that the intensity distribution at specific positions in the x direction and y direction is demonstrated as a waveform. As is clearly discernible from the figure, the radiation characteristic of the optical element in the far field, contrary to the case illustrated in FIG. 6, has a distinct curvature perpendicular to the radiation direction. On the other hand, this radiation characteristic also exhibits a distinct bright/dark transition. This simulation also assumed that the light source is fitted centrally with respect to the light entry area F of the optical element.

In FIG. 10 shows the projection of the light entry area F of the inventive optical element, in this case with a rectangular cross section, with a semiconductor light source 60 centrally adjoining the latter. In the general case, the semiconductor light source 60 is applied centrally on the light entry area, as shown in FIG. 110. In this case, in a beneficial manner, the thickness dimension of the optical element is chosen such that it exceeds the dimensions of the semiconductor light source 60 as little as possible. This gives rise to optical elements with an optimally small space requirement, which makes it possible to accommodate a multiplicity of optical elements in a very small space within an illumination source according to the invention and thus to obtain a maximum light power.

What is achieved by displacing the semiconductor light source 60 along the connecting line between the points P1 and P2 is that the light emerges asymmetrically from the optical element. In this case, it is conceivable either to position the semiconductor light source 60 fixedly at an arbitrary location along said connecting line, in order to obtain the desired asymmetrical radiation characteristic, or else to arrange the optical element in a displaceable manner above the semiconductor light source 60, so that the desired asymmetry of the light emission can be obtained by suitably displacing the optical element with respect to the semiconductor light source 60. As an alternative, it is also conceivable to arrange a plurality of semiconductor light sources directly instead of a displaceable optical element at the light entry area F of the individual optical element along the connecting line between P1 and P2. The luminous characteristic of the light emerging from the optical element can thus be altered advantageously without mechanical adjustment, simply through targeted electrical driving and selection.

In the case of the arrangement of the optical elements with respect to the illumination device according to the invention, it is advantageously conceivable to individually arrange the individual semiconductor light sources 60 with respect to the respective optical elements arranged in an array such that the illumination device has an asymmetrical emission characteristic. In a supplementary manner or as an alternative, however, it is also conceivable to obtain the asymmetrical radiation characteristic by means of an arrangement of individually shaped optical elements adapted to the desired light emission; in this case, it is conceivable to embody one portion of the optical elements with a rectangular light entry area F (corresponding to FIG. 10) and another portion of the optical elements with trapezoidal light entry areas F (corresponding to FIG. 8). Moreover, it is possible, in a beneficial manner, for the optical elements to be embodied at least in portions in accordance with the configuration demonstrated in FIG. 7.

If a plurality of semiconductor light sources are directly assigned to at least some of the individual optical elements within the illumination device, then it is possible, in a simple manner, by means of electronic control, to obtain a pivoting of the luminous cone emitted by the device or generally a change in the asymmetrical illumination properties of the illumination device by driving a respective one of the plurality of semiconductor light sources assigned to an optical element. Such an alternate driving of the light sources fitted to an individual optical element leads to the same beam pivoting as is the case for displaceably arranged lens optical elements from the prior art, but without having to have recourse to a susceptible, not very robust mechanism. Furthermore this advantageous configuration also affords the possibility of individually controlling the individual optical elements within a group of optical elements without complexity; this cannot be realized economically practically in the case of a mechanically variable deflection device.

The illumination device is configured particularly beneficially such that the semiconductor light sources can be dimmed or activated and deactivated driven jointly in groups or individually independently of the others in order to be able to illuminate the surroundings in a targeted manner and in a manner adapted to the situation.

In a particularly advantageous manner, the inventive illumination device is suitable for use as a headlight in a motor vehicle in order to asymmetrically illuminate the surroundings in front of the vehicle.

In a beneficial manner, in the case of use in a motor vehicle, the individual optical elements assigned to the headlight are oriented with regard to the road surface such that the x axes of the optical elements run essentially parallel thereto; i.e. the individual optical elements should be arranged such that they are situated essentially perpendicular (corresponding to FIG. 4, for example).

1. An illumination device, in particular for use in a motor vehicle, which is formed by an array of individual optical elements that are in each case assigned at least one semiconductor light source, in particular a light emitting diode, wherein
the light entry opening of the optical elements have an elongate, essentially rectangular form,
the optical elements have, perpendicular to the light entry area, a central region whose projection into a two-dimensional plane corresponds to a cylindrical two-dimensional Cartesian oval,
and said central region is combined with a parabolic reflector.

2. The illumination device as claimed in claim 1, wherein
the outer areas A and B of the reflector are rotated in the direction of the central region of the optical element such that all beams emerging from the optical element are substantially parallel.

3. The illumination device as claimed in claim 1, wherein
the outer areas A and B of the reflector are embodied such that they are mirror-coated or totally reflective.

4. The illumination device as claimed in claim 1, wherein
the side areas E of the optical element are inclined in such a way that the optical element tapers from the light exit area G toward the light entry area F.

5. The illumination device as claimed in claim 4, wherein
the side areas are formed, in particular by means of mirror-coating or curvature, such that a large acceptance angle is produced in the beam direction.

6. The illumination device as claimed in claim 1, wherein
the cross section of the light entry area of the individual optical elements have, in a departure from the rectangular form, a trapezoidal form whose side areas are inclined by the angles α and β with respect to the normal to the base area.

7. The illumination device as claimed in claim 1, wherein
at least one of the individual optical elements is assigned a plurality of semiconductor light sources.

8. The illumination device as claimed in claim 1, wherein
the individual semiconductor light sources can be switched individually.

9. The illumination device as claimed in claim 1, wherein
the optical elements and the semiconductor light sources are arranged such that they are displaceable with respect to one another.

10. A method for driving an illumination device as claimed in one of the preceding claims, wherein
the semiconductor light sources can be driven individually in a manner dependent on the desired radiation characteristic,
it being possible in this case for the semiconductor sources to be entirely or partly activated.

11. The method as claimed in claim 10, wherein
for the case where a plurality of semiconductor light sources are assigned to an individual optical element, these are driven in a manner dependent on the desired radiation characteristic.

12. The method as claimed in claim 10, wherein
the lenses and the semiconductor light sources are displaced relative to one another for the purpose of changing the emission characteristic of the illumination device.

13. The use of the illumination device as claimed in claim 10 as a motor vehicle headlight for asymmetrical illumination of the surroundings in front of a motor vehicle.
